(19) United States
(12) Patent Application Publication
(10) Pub. No.: US 2026/0347022 A1
(43) Pub. Date: Nov. 5, 2026

(54) DRONE AND DRONE BLADE CONTROL METHOD AND DEVICE

(71) Applicant: Hollyway Group Pte. Ltd., Singapore (SG)

(72) Inventor: Larry LEE, Singapore (SG)

(21) Appl. No.: 19/196,508

(22) Filed: May 1, 2025

(51) Int. Cl. B64U 40/10; G05D 3/12

(52) U.S. Cl. CPC B64U 40/10; G05D 3/12

(57) ABSTRACT

This application presents a method, device, and drone system for blade control, focusing on foreign object detection within a drone hangar. A driving device is controlled to perform movements based on preset detection parameters, including direction and quantity, to generate movement results. These results are used to determine whether any foreign objects are present in the hangar. If no foreign objects are detected, the drone blades are rotated to a preset angle, and a closure instruction is issued to shut the hangar, completing the blade positioning process. This method ensures that foreign object detection occurs before hangar closure during drone landing, reducing potential damage to both the drone and the hangar. By confirming a clear environment, the system safely moves the blades to the limit switch position before closing the hangar, thereby enhancing landing safety and positioning accuracy.

### TECHNICAL FIELD

The present application relates to the technical field of drones, and more specifically, to a drone and drone blade control method and device.

### BACKGROUND

With the development of the low-altitude economy, the use of drones in various industries is becoming increasingly widespread. Drones depart from a hangar, execute tasks sent by a client terminal, and then automatically return and land in the hangar. When landing in the hangar, it is necessary to rotate drone blades to a designated angle before sending a closure instruction to the hangar to close the hangar. However, during the actual landing process, foreign objects may appear in the hangar. For example, tree branches may fall into the hangar. In such cases, the tree branches may interfere with the positioning of the blades, potentially causing damage to both the blades and the hangar. Therefore, how to enable the drone to land safely and safely position the blades is an urgent problem that needs to be solved.

### SUMMARY

The present application provides a method, device, and drone for controlling drone blades. The technical solution of the present application provides controlling a driving device, according to preset foreign object detection requirements, to perform movements corresponding to the preset foreign object detection requirements to obtain movement results of the driving device, wherein, the preset foreign object detection requirements at least comprise a movement direction and a movement quantity; determining a foreign object detection result in a hangar based on the movement results of the driving device; controlling the drone blades to rotate to a preset angle when the foreign object detection result in the hangar indicates that there is no foreign object in the hangar, and then sending a closure instruction to the hangar to close the hangar, thereby completing a blade positioning operation. The present application provides first detecting whether there is a foreign object stuck in the hangar when the drone lands in the hangar, reducing the risk of damage to the structure of the drone and the hangar. Under the condition of ensuring that there is no foreign object, the blades are controlled to move to the position of the limit switch, and then the hangar is closed, thereby improving the safety of drone landing and blade positioning.

In a first aspect, the present application provides a drone blade control method, the method comprising:
Controlling a driving device, according to preset foreign object detection requirements, to perform movements corresponding to the preset foreign object detection requirements to obtain movement results of the driving device, wherein, the preset foreign object detection requirements at least comprise a movement direction and a movement quantity; Determining a foreign object detection result in the hangar based on the movement results of the driving device;
Controlling the drone blades to rotate to a preset angle when the foreign object detection result in the hangar indicates that there is no foreign object in the hangar, and then sending a closure instruction to the hangar to close the hangar, thereby completing a blade positioning operation.

The present application provides first detecting whether there is a foreign object stuck in the hangar when the drone lands in the hangar, reducing the risk of damage to the structure of the drone and the hangar. Under the condition of ensuring that there is no foreign object, the blades are controlled to move to the position of the limit switch, and then the hangar is closed, thereby improving the safety of drone landing and blade positioning.

Optionally, the movement direction at least comprises clockwise movement and counterclockwise movement, and the movement quantity refers to the number of loops; Controlling a driving device, according to preset foreign object detection requirements, to perform movements corresponding to the preset foreign object detection requirements to obtain movement results of the driving device comprises:
Controlling the driving device to rotate clockwise for N loops to obtain a first movement result, the first movement result at least comprising a first movement time;
Controlling the driving device to rotate counterclockwise for M loops to obtain a second movement result, the second movement result at least comprising a second movement time; wherein, N and M are natural numbers greater than 1;
Determining the first movement result and the second movement result as the movement results of the driving device.

In the present application, the drone controls the driving device to move according to the preset foreign object detection requirements to obtain the movement results of the driving device. In this way, it can be judged whether the driving device has become stuck based on the movement results.

Optionally, determining a foreign object detection result in the hangar based on the movement results of the driving device comprises:
Determining a movement state of the driving device of the drone based on the first movement time and the second movement time;
Determining whether there is a foreign object in the hangar based on the movement state of the driving device of the drone.

In the present application, the movement state of the drone blades is determined based on the time consumed by the driving device during clockwise and counterclockwise rotations, thereby determining whether a foreign object exists in the hangar.

Optionally, determining a movement state of the driving device of the drone based on the first movement time and the second movement time comprises:
Separately comparing the first movement time and the second movement time with the movement time in the absence of a foreign object;
If the times are the same as the movement time in the absence of a foreign object, determining the movement state of the drone blades corresponding to the same movement time in the absence of a foreign object to be a movement state without a foreign object;
If the times are different from the movement time in the absence of a foreign object, determining the movement state of the drone blades corresponding to the different movement time to be a movement state with a foreign object;
Determining the movement state without a foreign object and the movement state with a foreign object to be the movement states of the drone blades.

In the present application, the first movement time and the second movement time are separately compared with the movement time in the absence of a foreign object. Based on the comparison results, the movement state of the drone blades is determined.

Optionally, determining whether there is a foreign object in the hangar based on the movement state of the driving device of the drone comprises:
When both the first movement state and the second movement state are movement states with a foreign object, it is determined that there is a foreign object in the hangar;
When one of the first movement state and the second movement state is a movement state with a foreign object, it is determined that there is no foreign object in the hangar.

In the present application, the first movement state and the second movement state are judged separately as a movement state with or without a foreign object, thereby determining whether there is a foreign object in the hangar.

Optionally, controlling the drone blades to rotate to a preset angle when the foreign object detection result in the hangar indicates that there is no foreign object in the hangar, and then sending a closure instruction to the hangar to close the hangar, thereby completing a blade positioning operation comprises:
Obtaining the voltage value of the driving device when the drone blades are in a state without a foreign object;
Determining that the drone blades have moved to the limit position when the voltage value of the driving device is greater than a preset voltage threshold, sending a closure instruction to the hangar to close the hangar, and completing the blade positioning operation.

Optionally, determining that the drone blades have moved to the limit position when the voltage value of the driving device is greater than a preset voltage threshold comprises:
Determining that the drone blades have moved to the limit position when the voltage value of the driving device is greater than a preset voltage threshold, and resetting a counter to zero;
Obtaining a value of the counter during steady movement of the driving device;
Controlling the driving device to stop moving when the value of the counter exceeds a preset time threshold.

In the present application, the blades are driven to the position of the limit switch. By monitoring the output voltage of the driving device, power to the driving device is actively cut off, eliminating the risk of the blades being rebounded.

In a second aspect, the present application provides a drone blade control device, the device comprising:
A control module used for controlling a driving device, according to preset foreign object detection requirements, to perform movements corresponding to the preset foreign object detection requirements to obtain movement results of the driving device, wherein, the preset foreign object detection requirements at least comprise a movement direction and a movement quantity;
A determination module used for determining a foreign object detection result in the hangar based on the movement results of the driving device;
A blade positioning module used for controlling the drone blades to rotate to a preset angle when the foreign object detection result in the hangar indicates that there is no foreign object in the hangar, and then sending a closure instruction to the hangar to close the hangar, thereby completing a blade positioning operation.

The present application provides first detecting whether there is a foreign object stuck in the hangar when the drone lands in the hangar, reducing the risk of damage to the structure of the drone and the hangar. Under the condition of ensuring that there is no foreign object, the blades are controlled to move to the position of the limit switch, and then the hangar is closed, thereby improving the safety of drone landing and blade positioning.

Optionally, the movement direction at least comprises clockwise movement and counterclockwise movement, and the movement quantity refers to the number of loops.

The control module is used for:
Controlling the driving device to rotate clockwise for N loops to obtain a first movement result, the first movement result at least comprising a first movement time;
Controlling the driving device to rotate counterclockwise for M loops to obtain a second movement result, the second movement result at least comprising a second movement time;
wherein, N and M are natural numbers greater than 1;
Determining the first movement result and the second movement result as the movement results of the driving device.

In the present application, the drone controls the driving device to perform movements according to the preset foreign object detection requirements, thereby obtaining the movement results of the driving device. This allows the determination of whether the driving device has become stuck based on the movement results.

Optionally, the determination module is used for:
Determining a movement state of the driving device of the drone based on the first movement time and the second movement time;
Determining whether there is a foreign object in the hangar based on the movement state of the driving device of the drone.

In the present application, the movement state of the drone blades is determined based on the time consumed by the driving device during clockwise and counterclockwise rotations, thereby determining whether a foreign object exists in the hangar.

Optionally, the determination module is used for:
Separately comparing the first movement time and the second movement time with the movement time in the absence of a foreign object;
If the times are the same as the movement time in the absence of a foreign object, determining the movement state of the drone blades corresponding to the same movement time in the absence of a foreign object to be a movement state without a foreign object;
If the times are different from the movement time in the absence of a foreign object, determining the movement state of the drone blades corresponding to the different movement time to be a movement state with a foreign object;
Determining the movement state without a foreign object and the movement state with a foreign object to be the movement states of the drone blades.

In the present application, the first movement time and the second movement time are compared with the no-foreign-object movement time, and the movement state of the drone blades is determined based on the comparison results.

Optionally, the determination module is used for:
When both the first movement state and the second movement state are movement states with a foreign object, it is determined that there is a foreign object in the hangar;
When one of the first movement state and the second movement state is a movement state with a foreign object, it is determined that there is no foreign object in the hangar.

In the present application, the first movement state and the second movement state are judged separately as a movement state with or without a foreign object, thereby determining whether there is a foreign object in the hangar.

Optionally, the blade positioning module is used for:
Obtaining the voltage value of the driving device when the drone blades are in a state without a foreign object;
Determining that the drone blades have moved to the limit position when the voltage value of the driving device is greater than a preset voltage threshold, sending a closure instruction to the hangar to close the hangar, and completing the blade positioning operation.

Optionally, the blade positioning module is used for:
Determining that the drone blades have moved to the limit position when the voltage value of the driving device is greater than a preset voltage threshold, and resetting a counter to zero;
Obtaining a value of the counter during steady movement of the driving device;
Controlling the driving device to stop moving when the value of the counter exceeds a preset time threshold.

In the present application, the blades are driven to the position of the limit switch. By monitoring the output voltage of the driving device, power to the driving device is actively cut off, eliminating the risk of the blades being rebounded.

In a third aspect, the present application provides a drone, comprising a memory, a processor, and a computer program stored in the memory and executable on the processor, wherein when the processor executes the program, the drone blade control method as described in any embodiment of the first aspect can be implemented.

### BRIEF DESCRIPTION OF THE DRAWINGS

In order to more clearly illustrate the technical solutions of some embodiments of the present application, the following will briefly introduce the drawings required to be used in some embodiments of the present application. It should be understood that the following drawings only show some embodiments of the present application, and therefore should not be regarded as limiting the scope. For ordinary technicians in this field, other relevant drawings can also be obtained based on these drawings without creative work.

FIG. 1 is a flow chart of a drone blade control method according to an embodiment of the present application;

FIG. 2 is a flow chart of another drone blade control method according to an embodiment of the present application;

FIG. 3 is a schematic diagram of a coordinate system voltage of a motor before and after encountering a limit device during a blade positioning process according to an embodiment of the present application;

FIG. 4 is a structural schematic diagram of a drone blade control device provided according to an embodiment of the present application;

FIG. 5 is a schematic diagram of a drone provided according to an embodiment of the present application.

### DETAILED DESCRIPTION OF EMBODIMENTS

The following will describe the technical solutions in some embodiments of the present application in conjunction with the drawings in some embodiments of the present application.

It should be noted that similar numbers and letters represent similar elements in the following drawings. Therefore, once an element has been defined in one drawing, it does not need to be further defined and explained in the subsequent drawings. At the same time, in the description of the present application, the terms “first”, “second”, etc. are only used to distinguish the description and should not be understood as indicating or implying relative importance.

With the development of the low-altitude economy, the use of drones in various industries is becoming increasingly widespread. Drones depart from the hangar, execute tasks sent by a client terminal, and then automatically return and land in the hangar. When landing in the hangar, it is necessary to rotate drone blades to a designated angle before sending a closure instruction to the hangar to close the hangar. However, during the actual landing process, foreign objects may appear in the hangar. For example, tree branches may fall into the hangar. In such cases, the tree branches may interfere with the positioning of the blades, potentially causing damage to both the blades and the hangar. Therefore, how to enable the drone to land safely and safely position the blades is an urgent problem that needs to be solved. In view of this, some embodiments of the present application provide a drone blade control method, comprising controlling a driving device, according to preset foreign object detection requirements, to perform movements corresponding to the preset foreign object detection requirements to obtain movement results of the driving device, wherein, the preset foreign object detection requirements at least comprise a movement direction and a movement quantity; determining a foreign object detection result in the hangar based on the movement results of the driving device; controlling the drone blades to rotate to a preset angle when the foreign object detection result in the hangar indicates that there is no foreign object in the hangar, and then sending a closure instruction to the hangar to close the hangar, thereby completing a blade positioning operation. The embodiments of the present application first detect whether there is a foreign object stuck in the hangar when the drone lands in the hangar, reducing the risk of damage to the structure of the drone and the hangar. Under the condition of ensuring that there is no foreign object, the blades are controlled to move to the position of the limit switch, and then the hangar is closed, thereby improving the safety of drone landing and blade positioning.

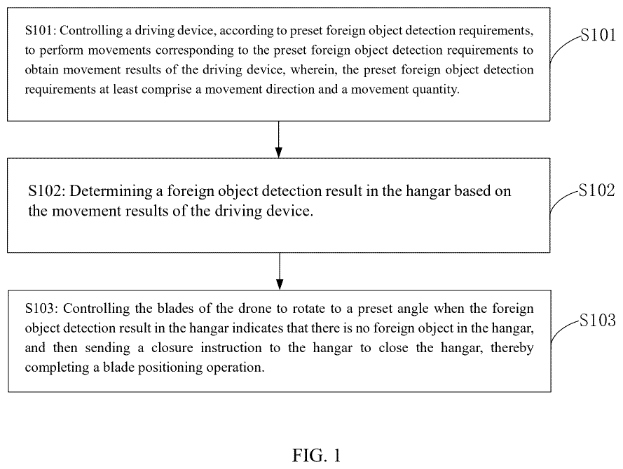

As shown in FIG. 1, an embodiment of the present application provides a drone blade control method, which comprises the following steps:
S101: Controlling a driving device, according to preset foreign object detection requirements, to perform movements corresponding to the preset foreign object detection requirements to obtain movement results of the driving device, wherein, the preset foreign object detection requirements at least comprise a movement direction and a movement quantity.

Specifically, when the drone flies into the hangar, the drone controls the driving device, according to the preset foreign object detection requirements, to perform movements corresponding to the preset foreign object detection requirements to obtain the movement results of the driving device. The driving device is a motor. For example, the driving device is controlled to rotate clockwise for more than one loop, or the driving device is controlled to rotate counterclockwise for more than one loop. A processor inside the drone is connected to the driving device, and an output end of the driving device is used for driving movement of the blades.

S102: Determining a foreign object detection result in the hangar based on the movement results of the driving device.

Specifically, the drone drives the motor to move and obtains the movement results of the driving device, wherein, the movement results at least comprise normal movement and stuck movement. By determining normal movement and stuck movement, it can be judged whether there is a foreign object in the hangar, thereby obtaining the foreign object detection result.

S103: Controlling the drone blades to rotate to a preset angle when the foreign object detection result in the hangar indicates that there is no foreign object in the hangar, and then sending a closure instruction to the hangar to close the hangar, thereby completing a blade positioning operation.

Specifically, when the drone detects that there is no foreign object in the hangar, the drone controls the blades to rotate to a preset angle, namely, to the position of a limit switch, and sends a closure instruction to a processor in the hangar. The processor in the hangar controls the hangar door to close based on the closure instruction, completing the blade positioning operation.

The present application provides first detecting whether there is a foreign object stuck in the hangar when the drone lands in the hangar, reducing the risk of damage to the structure of the drone and the hangar. Under the condition of ensuring that there is no foreign object, the blades are controlled to move to the position of the limit switch, and then the hangar is closed, thereby improving the safety of drone landing and blade positioning.

Another embodiment of the present application provides further supplementary descriptions of the drone blade control method provided in the embodiment described above.

Optionally, the movement direction at least comprises clockwise movement and counterclockwise movement, and the movement quantity refers to the number of loops.

Controlling a driving device, according to preset foreign object detection requirements, to perform movements corresponding to the preset foreign object detection requirements to obtain movement results of the driving device comprises:
Controlling the driving device to rotate clockwise for N loops to obtain a first movement result, the first movement result at least comprising a first movement time;
Controlling the driving device to rotate counterclockwise for M loops to obtain a second movement result, the second movement result at least comprising a second movement time; wherein, N and M are natural numbers greater than 1;
Determining the first movement result and the second movement result as the movement results of the driving device.

The drone controls the motor to rotate clockwise for 1.5 loops and rotate counterclockwise for 1.5 loops. During the rotation, the movement results are obtained, and the movement results at least comprise the movement time. The movement result of the clockwise rotation for 1.5 loops and the movement result of the counterclockwise rotation for 1.5 loops are determined as the movement results of the driving device, wherein, the movement results comprise normal movement and stuck movement.

In the present application, the drone controls the driving device to move according to the preset foreign object detection requirements to obtain the movement results of the driving device. In this way, it can be judged whether the driving device has become stuck based on the movement results.

Optionally, determining a foreign object detection result in the hangar based on the movement results of the driving device comprises:
Determining a movement state of the driving device of the drone based on the first movement time and the second movement time;
Determining whether there is a foreign object in the hangar based on the movement state of the driving device of the drone.

In an embodiment of the present application, when there is no foreign object, the time taken for the drone to rotate the motor for one loop is fixed. By comparing the obtained first movement time and second movement time with the time required in the absence of a foreign object, it can be judged whether the motor has become stuck based on a comparison result, thereby determining the movement state of the driving device. Furthermore, the movement state of the blades is determined based on the movement state of the driving device. A stuck movement occurs as a result of a foreign object having fallen into the hangar. Therefore, whether there is a foreign object in the hangar can be determined based on the movement state of the motor.

In the present application, the movement state of the drone blades is determined based on the time consumed by the driving device during clockwise and counterclockwise rotations, thereby determining whether a foreign object exists in the hangar.

Optionally, determining a movement state of the driving device of the drone based on the first movement time and the second movement time comprises:
Separately comparing the first movement time and the second movement time with the movement time in the absence of a foreign object;
If the times are the same as the movement time in the absence of a foreign object, determining the movement state of the drone blades corresponding to the same movement time in the absence of a foreign object to be a movement state without a foreign object;
If the times are different from the movement time in the absence of a foreign object, determining the movement state of the drone blades corresponding to the different movement time to be a movement state with a foreign object;
Determining the movement state without a foreign object and the movement state with a foreign object to be the movement states of the drone blades.

In the present application, the first movement time and the second movement time are separately compared with the movement time in the absence of a foreign object. Based on the comparison results, the movement state of the drone blades is determined.

Optionally, determining whether there is a foreign object in the hangar based on the movement state of the driving device of the drone comprises:
When both the first movement state and the second movement state are movement states with a foreign object, it is determined that there is a foreign object in the hangar;
When one of the first movement state and the second movement state is a movement state with a foreign object, it is determined that there is no foreign object in the hangar.

In the present application, the first movement state and the second movement state are judged separately as a movement state with or without a foreign object, thereby determining whether there is a foreign object in the hangar.

Optionally, controlling the drone blades to rotate to a preset angle when the foreign object detection result in the hangar indicates that there is no foreign object in the hangar, and then sending a closure instruction to the hangar to close the hangar, thereby completing a blade positioning operation comprises:
Obtaining the voltage value of the driving device when the drone blades are in a state without a foreign object;
Determining that the drone blades have moved to the limit position when the voltage value of the driving device is greater than a preset voltage threshold, sending a closure instruction to the hangar to close the hangar, and completing the blade positioning operation.

Optionally, determining that the drone blades have moved to the limit position when the voltage value of the driving device is greater than a preset voltage threshold comprises:
Determining that the drone blades have moved to the limit position when the voltage value of the driving device is greater than a preset voltage threshold, and resetting a counter to zero;
Obtaining a value of the counter during steady movement of the driving device;
Controlling the driving device to stop moving when the value of the counter exceeds a preset time threshold.

In the present application, the blades are driven to the position of the limit switch. By monitoring the output voltage of the driving device, power to the driving device is actively cut off, eliminating the risk of the blades being rebounded.

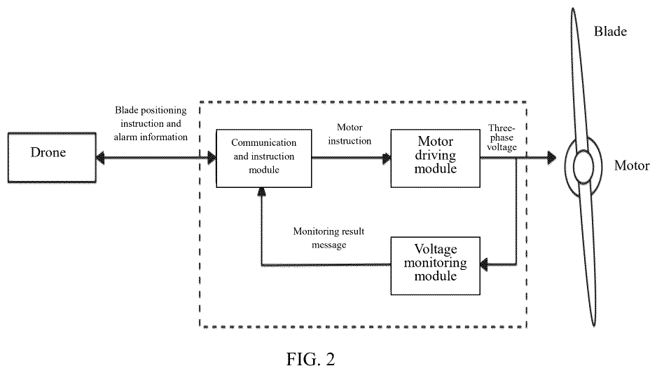

As shown in FIG. 2, the drone comprises a communication and instruction module, a motor driving module, and a voltage monitoring module. These three modules are used for achieving complete blade positioning, specifically comprising: a foreign object pre-detection function and a blade resetting function.

1) The foreign object pre-detection function comprises:

The drone drives the motor to rotate clockwise for 1.5 loops and counterclockwise for 1.5 loops. If the limit device (unidirectional rotation limiter) is normal and there is no foreign object interfering with the blades in the hangar, the expected result is that one operation will not trigger an abnormal voltage while the other operation will trigger an abnormal voltage. If there is a foreign object interfering with the blades, both operations will trigger abnormalities. If neither operation triggers an abnormality, this is also abnormal.

Step 1: After receiving a “Start blade positioning” instruction, the communication and instruction module sends instructions to the motor driving module to rotate clockwise for 1.5 loops and counterclockwise for 1.5 loops.

Step 2: The motor driving module drives the motor to rotate clockwise for 1.5 loops and then counterclockwise for 1.5 loops according to the instructions in Step 1. During rotation of the motor, the voltage monitoring module monitors voltage data in real time. When the two processes are completed, if one process triggers an abnormal voltage and the other does not trigger an abnormality, the voltage monitoring module reports two messages to the communication and instruction module: “No abnormality” and “The direction of rotation that triggered the voltage abnormality” (i.e., recording whether the abnormality was triggered during clockwise or counterclockwise rotation). In other cases, the voltage monitoring module reports a single message: “Abnormality detected” to the communication and instruction module.

Step 3: If the communication and instruction module receives the “Abnormality detected” message from the voltage monitoring module, a message “Blade positioning abnormality, please check equipment” is sent to a host computer. If the communication and instruction module receives the two messages, “No abnormality” and “The direction of rotation that triggered the voltage abnormality” (i.e., recording whether the abnormality was triggered during clockwise or counterclockwise rotation), the blade resetting function phase is entered.

Blade resetting function comprises:
When the foreign object pre-detection passes and there is no abnormality, the blades are rotated in a specified direction. The voltage monitoring module continuously monitors the voltage. If an abnormality occurs (i.e., the blades reach the position of the limit device), the communication and instruction module actively cuts power to the motor based on the monitoring results, ensuring that the blades stop at the position of the limit device.

Step 1: After the foreign object pre-detection function passes, the communication and instruction module sends an instruction to the motor driving module to rotate 1.5 loops in the direction reported in “The direction of rotation that triggered the voltage abnormality” during the foreign object pre-detection function.

Step 2: The motor driving module drives the motor to rotate according to the instruction in Step 1. During this period, the voltage monitoring module monitors voltage data in real-time. When the voltage first exceeds an upper threshold value, the voltage monitoring module starts an internal counter T. Counting rules are as follows: if a q-axis voltage exceeds an upper threshold Vmax, the counter is reset to zero; otherwise, the counter increments by 1 per cycle. When the counter value exceeds Tₗᵢₘᵢₜ, the voltage monitoring module reports the message “Reached the limit device” to the communication and instruction module.

Step 3: After the communication and instruction module receives the “Reached the limit device” message from the voltage monitoring module, on the one hand, the communication and instruction module sends a stop motor instruction (i.e., power off) to the motor driving module, and on the other hand, reports the message “Blade positioning completed” to the host computer, ending the blade positioning process.

In the above steps, T is a counting variable, and Vmax and Tₗᵢₘᵢₜ are preset parameters.

As shown in FIG. 2, the communication and instruction module performs three functions: achieving two-way information interaction with the host computer, receiving information from the voltage monitoring module, and issuing motor instructions.

The logic comprises the following:
Logic One: After receiving the “Start blade positioning” instruction from the host computer, the instructions are sent to the motor driving module to rotate 1.5 loops clockwise and 1.5 loops counterclockwise;
Logic Two: After receiving the “No abnormality” and “The direction of rotation that triggered the voltage abnormality” messages from the voltage monitoring module, the instruction to rotate 1.5 loops in the corresponding direction is sent to the motor driving module;
Logic Three: After receiving the “Abnormality detected” message from the voltage monitoring module, the message “Blade positioning abnormality, please check equipment” is reported to the host computer;
Logic Four: After receiving the “Reached the limit device” message from the voltage monitoring module, the stop motor instruction is sent to the motor driving module, and the message “Blade positioning completed” is reported to the host computer.

The motor driving module is used for receiving motor instructions from the communication and instruction module and controlling the rotation of the motor.

Assuming that the set rotational speed of the motor is ω (unit: rad/s) and the permanent magnet pole pair number of the motor is p, the time required to rotate 1.5 loops can be calculated as:

$$t = \frac{1.5 \times 2 p π}{ω} .$$

At this time, based on the set torque, a current-loop closed-loop control scheme is adopted, and a time control signal is applied to the motor accordingly.

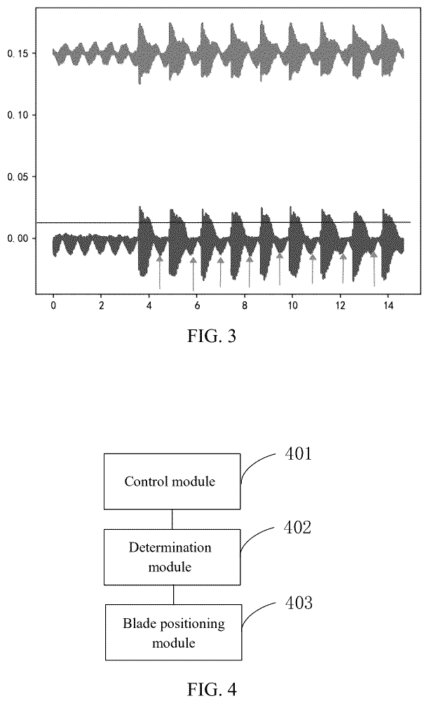

The voltage monitoring module is used for monitoring the normalized voltage signals of the motor under the dq-coordinate system in real time. FIG. 3 shows the dq-coordinate system voltage of the motor before and after encountering the limit device during the blade positioning process. The horizontal axis represents time in units of seconds (s), and the vertical axis represents the normalized d-axis voltage (orange) and q-axis voltage (blue). Within the first 3.5 seconds, the blades rotate with the motor without reaching the limit device. At the 3.5-second mark, the blades reach the limit switch. The blades being subjected to a driving force of the motor and a reactive force of the limit device exhibits as a characteristic increase in the voltage. At this point, the blades alternately exhibit two phenomena at the limit device: oscillatory vibration (increased voltage) and pressing against the limit device (indicated by the green arrow).

In summary, the functions of the voltage monitoring module are as follows:
determining whether the blades have reached the limit device by monitoring the q-axis voltage of the motor, and at the moment of the blades pressing against the limit device, sending the “Reached the limit device” message to the communication and instruction module, which handles the subsequent functions.

Logic for determining the blades reaching the limit device:
Voltage data during the blade positioning process of normal motor rotation and motor stalling due to the limit device is collected offline in advance, and the q-axis upper threshold voltage Vmax is set accordingly. During online monitoring, if the q-axis voltage exceeds the threshold, i.e., Vq>Vmax, it is considered that the blades have reached the limit device.

Logic for sending the “Reached the limit device” message:
After determining that the blades have reached the limit device, the counter T is started. The counting rules are as follows: if the q-axis voltage exceeds the upper threshold Vmax, the counter is reset to zero; otherwise, the counter increments by 1 per cycle. When the counter value exceeds Tlimit, the voltage monitoring module reports the “Reached the limit device” message to the communication and instruction module. The basis for this selection (as illustrated in FIG. 3) is the desire for the blades to reliably avoid the oscillatory vibration phase and send the “Reached the limit device” message during the phase where the blades press against the limit device (indicated by the green arrow). Subsequently, the motor output is shut off by the following modules, ultimately completing the entire blade positioning process.

The embodiments of the present application propose a blade positioning method for multi-rotor drones. The method comprises two functions: foreign object pre-detection and blade resetting. Each function requires the use of three fundamental modules: motor driving, voltage monitoring, and communication and instruction. Wherein, the foreign object pre-detection module is used for detecting whether a foreign object is stuck in the hangar, promptly issuing an alarm, and reducing the risk of structural damage. After ensuring that there is no foreign object, the blade resetting module drives the blades to the limit device. Based on the monitoring results of the voltage monitoring module, the motor is actively powered off, eliminating the risk of blade rebound.

It should be noted that the implementable methods in the present embodiment can be implemented independently or in any combination without conflict, which are not limited by the present application.

Another embodiment of the present application provides a drone blade control device for executing the drone blade control method described above.

FIG. 4 is a structural diagram of the drone blade control device provided by an embodiment of the present application. The drone blade control device at least comprises: a control module 401, a determination module 402, and a blade positioning module 403, wherein:

The control module 401 is used for controlling a driving device, according to preset foreign object detection requirements, to perform movements corresponding to the preset foreign object detection requirements to obtain movement results of the driving device, wherein, the preset foreign object detection requirements at least comprise a movement direction and a movement quantity.

The determination module 402 is used for determining a foreign object detection result in the hangar based on the movement results of the driving device.

The blade positioning module 403 is used for controlling the drone blades to rotate to a preset angle when the foreign object detection result in the hangar indicates that there is no foreign object in the hangar, and then sending a closure instruction to the hangar to close the hangar, thereby completing a blade positioning operation.

Regarding the device in the present embodiment, the specific methods by which each module performs operations have been described in detail in the embodiments of the related method and will not be elaborated here.

The present application provides first detecting whether there is a foreign object stuck in the hangar when the drone lands in the hangar, reducing the risk of damage to the structure of the drone and the hangar. Under the condition of ensuring that there is no foreign object, the blades are controlled to move to the position of the limit switch, and then the hangar is closed, thereby improving the safety of drone landing and blade positioning.

Another embodiment of the present application provides a further supplementary explanation for the above-mentioned drone blade control device.

Optionally, the movement direction at least comprises clockwise movement and counterclockwise movement, and the movement quantity refers to the number of loops.

The control module is used for:
Controlling the driving device to rotate clockwise for N loops to obtain a first movement result, the first movement result at least comprising a first movement time;
Controlling the driving device to rotate counterclockwise for M loops to obtain a second movement result, the second movement result at least comprising a second movement time; wherein, N and M are natural numbers greater than 1;
Determining the first movement result and the second movement result as the movement results of the driving device.

In the present application, the drone controls the driving device to perform movements according to the preset foreign object detection requirements, thereby obtaining the movement results of the driving device. This allows the determination of whether the driving device has become stuck based on the movement results.

Optionally, the determination module is used for:
Determining a movement state of the driving device of the drone based on the first movement time and the second movement time;
Determining whether there is a foreign object in the hangar based on the movement state of the driving device of the drone.

In the present application, the movement state of the drone blades is determined based on the time consumed by the driving device during clockwise and counterclockwise rotations, thereby determining whether a foreign object exists in the hangar.

Optionally, the determination module is used for:
Separately comparing the first movement time and the second movement time with the movement time in the absence of a foreign object;
If the times are the same as the movement time in the absence of a foreign object, determining the movement state of the drone blades corresponding to the same movement time in the absence of a foreign object to be a movement state without a foreign object;
If the times are different from the movement time in the absence of a foreign object, determining the movement state of the drone blades corresponding to the different movement time to be a movement state with a foreign object;
Determining the movement state without a foreign object and the movement state with a foreign object to be the movement states of the drone blades.

In the present application, the first movement time and the second movement time are compared with the no-foreign-object movement time, and the movement state of the drone blades is determined based on the comparison results.

Optionally, the determination module is used for:
When both the first movement state and the second movement state are movement states with a foreign object, it is determined that there is a foreign object in the hangar;
When one of the first movement state and the second movement state is a movement state with a foreign object, it is determined that there is no foreign object in the hangar.

In the present application, the first movement state and the second movement state are judged separately as a movement state with or without a foreign object, thereby determining whether there is a foreign object in the hangar.

Optionally, the blade positioning module is used for:
Obtaining the voltage value of the driving device when the drone blades are in a state without a foreign object;
Determining that the drone blades have moved to the limit position when the voltage value of the driving device is greater than a preset voltage threshold, sending a closure instruction to the hangar to close the hangar, and completing the blade positioning operation.

Optionally, the blade positioning module is used for:
Determining that the drone blades have moved to the limit position when the voltage value of the driving device is greater than a preset voltage threshold, and resetting a counter to zero;
Obtaining a value of the counter during steady movement of the driving device;
Controlling the driving device to stop moving when the value of the counter exceeds a preset time threshold.

In the present application, the blades are driven to the position of the limit switch. By monitoring the output voltage of the driving device, power to the driving device is actively cut off, eliminating the risk of the blades being rebounded.

Regarding the device in the present embodiment, the specific methods by which each module performs operations have been described in detail in the embodiments of the related method and will not be elaborated here.

It should be noted that the implementable methods in the present embodiment can be implemented independently or in any combination without conflict, which are not limited by the present application.

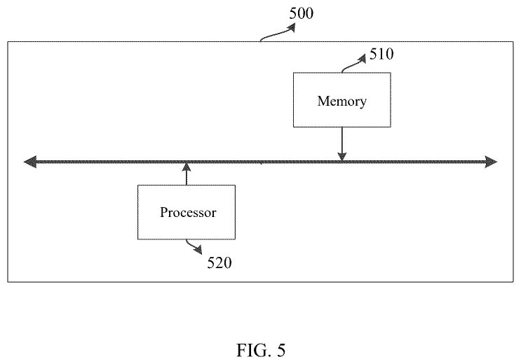

As shown in FIG. 5, some embodiments of the present application provide a drone 500. The drone 500 comprises a memory 510, a processor 520, and a computer program stored in the memory 510 and executable on the processor 520. The processor 520 can read and execute the program from the memory 510 via a bus 550 to implement any of the methods comprised in the above-mentioned drone blade control method.

The processor 520 can process digital signals and may comprise various computing structures, such as complex instruction set computing architecture, reduced instruction set computing architecture, or a hybrid architecture combining multiple instruction sets. In some embodiments, the processor 520 may be a microprocessor.

The memory 510 can store instructions executed by the processor 520 or data related to instruction execution. These instructions and/or data may comprise code for implementing some or all functions of one or more modules described in the embodiments of the present application. The processor 520 disclosed in the embodiments of the present application can execute the instructions stored in the memory 510 to implement the methods described above. The memory 510 comprises dynamic random-access memory, static random-access memory, flash memory, optical memory, or other memory known to those skilled in the art.

The above is merely an embodiment of the present application and is not intended to limit the scope of protection of the present application. For those skilled in the art, the present application may undergo various modifications and changes. Any modifications, equivalent replacements, or improvements made within the spirit and principles of the present application are comprised in the scope of protection of the present application. It should be noted that similar reference numbers and letters in the drawings below represent similar elements, so once an element has been defined in one figure, further definitions and explanations are not necessary in subsequent figures.

The above is merely a specific implementation of the present application. However, the scope of protection of the present application is not limited to this. Any changes or substitutions that can be easily conceived of by those skilled in the technical field of the present application within the disclosed technical scope should be covered within the scope of protection of the present application. Therefore, the scope of protection of the present application should be defined by the claims.

It should be noted that the relational terms such as “first” and “second” mentioned herein are merely used to distinguish one entity or operation from another entity or operation and do not necessarily require or imply any actual relationship or order between these entities or operations. Furthermore, the terms “comprising” or “including” and their variants are intended to cover non-exclusive inclusion, so a process, method, item, or device that comprises a list of elements is not limited to those elements but may comprise other elements not explicitly listed or elements inherent to such process, method, item, or device. Without additional constraints, an element defined by a statement such as “comprising one . . . ” does not exclude the presence of additional identical elements in the process, method, item, or device.

1. A drone blade control method, characterized in that, the method comprises:
controlling a driving device, according to preset foreign object detection requirements, to perform movements corresponding to the preset foreign object detection requirements to obtain movement results of the driving device, wherein, the preset foreign object detection requirements at least comprise a movement direction and a movement quantity;
determining a foreign object detection result in a hangar based on movement results of the driving device;
controlling drone blades to rotate to a preset angle when the foreign object detection result in the hangar indicates that there is no foreign object in the hangar, and then sending a closure instruction to the hangar to close the hangar, thereby completing a blade positioning operation.

2. The drone blade control method according to claim 1, characterized in that: the movement direction at least comprises clockwise movement and counterclockwise movement, and the movement quantity refers to the number of loops;
controlling a driving device, according to preset foreign object detection requirements, to perform movements corresponding to the preset foreign object detection requirements to obtain movement results of the driving device comprises:
controlling the driving device to rotate clockwise for N loops to obtain a first movement result, the first movement result at least comprising a first movement time;
controlling the driving device to rotate counterclockwise for M loops to obtain a second movement result, the second movement result at least comprising a second movement time; wherein, N and M are natural numbers greater than 1;
determining the first movement result and the second movement result as the movement results of the driving device.

3. The drone blade control method according to claim 2, characterized in that: determining a foreign object detection result in the hangar based on the movement results of the driving device comprises:
determining a movement state of the driving device of the drone based on the first movement time and the second movement time;
determining whether there is a foreign object in the hangar based on the movement state of the driving device of the drone.

4. The drone blade control method according to claim 3, characterized in that, determining a movement state of the driving device of the drone based on the first movement time and the second movement time comprises:
separately comparing the first movement time and the second movement time with the movement time in the absence of a foreign object;
if the times are the same as the movement time in the absence of a foreign object, determining the movement state of the drone blades corresponding to the same movement time in the absence of a foreign object to be a movement state without a foreign object;
if the times are different from the movement time in the absence of a foreign object, determining the movement state of the drone blades corresponding to the different movement time to be a movement state with a foreign object;
determining the movement state without a foreign object and the movement state with a foreign object to be the movement states of the drone blades.

5. The drone blade control method according to claim 3, characterized in that, determining whether there is a foreign object in the hangar based on the movement state of the driving device of the drone comprises:
when both the first movement state and the second movement state are movement states with a foreign object, it is determined that there is a foreign object in the hangar;
when one of the first movement state and the second movement state is a movement state with a foreign object, it is determined that there is no foreign object in the hangar.

6. The drone blade control method according to claim 4, characterized in that, controlling the drone blades to rotate to a preset angle when the foreign object detection result in the hangar indicates that there is no foreign object in the hangar, and then sending a closure instruction to the hangar to close the hangar, thereby completing a blade positioning operation comprises:
obtaining a voltage value of the driving device when the drone blades are in a state without a foreign object;
determining that the drone blades have moved to a limit position when the voltage value of the driving device is greater than a preset voltage threshold, sending a closure instruction to the hangar to close the hangar, and completing the blade positioning operation.

7. The drone blade control method according to claim 6, characterized in that, determining that the drone blades have moved to the limit position when the voltage value of the driving device is greater than a preset voltage threshold comprises:
determining that the drone blades have moved to the limit position when the voltage value of the driving device is greater than a preset voltage threshold, and resetting a counter to zero;
obtaining a value of the counter during steady movement of the driving device;
controlling the driving device to stop moving when the value of the counter exceeds a preset time threshold.

8. A drone blade control device, characterized in that, the device comprises:
a control module used for controlling a driving device, according to preset foreign object detection requirements, to perform movements corresponding to the preset foreign object detection requirements to obtain movement results of the driving device, wherein, the preset foreign object detection requirements at least comprise a movement direction and a movement quantity;
a determination module used for determining a foreign object detection result in the hangar based on the movement results of the driving device;
a blade positioning module used for controlling the drone blades to rotate to a preset angle when the foreign object detection result in the hangar indicates that there is no foreign object in the hangar, and then sending a closure instruction to the hangar to close the hangar, thereby completing a blade positioning operation.

9. The drone blade control device according to claim 8, characterized in that: the movement direction at least comprises clockwise movement and counterclockwise movement, and the movement quantity refers to the number of loops;
the determination module is used for:
controlling the driving device to rotate clockwise for N loops to obtain a first movement result, the first movement result at least comprising a first movement time;
controlling the driving device to rotate counterclockwise for M loops to obtain a second movement result, the second movement result at least comprising a second movement time; wherein, N and M are natural numbers greater than 1;
determining the first movement result and the second movement result as the movement results of the driving device.

10. A drone, characterized in that, the drone comprises a memory, a processor, and a computer program stored in the memory and executable on the processor, wherein, the processor can implement the drone blade control method described in claim 1 when executing the program.
